(19) United States
(12) Patent Application Publication
(10) Pub. No.: US 2013/0201946 A1
(43) Pub. Date: Aug. 8, 2013

(54) Transmission of Reference Signals

(71) Applicants: Timo Erkki Lunttila, Espoo (FI); Esa Tapani Tiirola, Kempele (FI); Kari Pekka Pajukoski, Oulu (FI); Kari Juhani Hooli, Oulu (FI)

(72) Inventors: Timo Erkki Lunttila, Espoo (FI); Esa Tapani Tiirola, Kempele (FI); Kari Pekka Pajukoski, Oulu (FI); Kari Juhani Hooli, Oulu (FI)

(73) Assignee: Nokia Siemens Networks Oy, Espoo (FI)

(21) Appl. No.: 13/806,165

(22) PCT Filed: Jun. 21, 2010
(86) PCT No.: PCT/EP2010/058710

§ 371 Date: Apr. 9, 2013

(51) Int. Cl. H04W 24/02

(52) U.S. Cl. CPC H04W 24/02
USPC 370/329; 370/328

(57) ABSTRACT

A mechanism for configuring stations for reference signalling is disclosed. A first station defines a pattern of configuration indications for use in reference signalling and communicates information of the pattern of configuration indications to at least one second station for configuring the at least one second station for reference signalling. After receiving the information of the pattern a second station can obtain information of subframes that associate with reference signalling there from. Upon detection of a trigger by the first station for transmission of a reference signal the second station can be configured for transmission of the reference signal based on the information obtained from the pattern.

The invention relates to transmission of reference signals in a communication system. More particularly, but not exclusively, the invention relates a mechanism for providing information for transmission of sounding reference signals.

A communication system can be seen as a facility that enables communication sessions between two or more entities such as mobile communication devices, base stations and/or other communication points. A communication system and compatible communicating entities typically operate in accordance with a given standard or specification which sets out what the various entities associated with the system are permitted to do and how that should be achieved. For example, the standards, specifications and protocols can define the manner how and based on which access technology communication devices can access the communication system and how communication shall be implemented between communicating devices, the elements of a communication network and/or other communication devices. In a wireless communication system at least a part of the communication between at least two stations occurs over a wireless link. Examples of wireless systems include public land mobile networks (PLMN) such as cellular networks, satellite based communication systems and different wireless local networks, for example wireless local area networks (WLAN). A wireless system can be divided into cells, and are therefore is often referred to as a cellular system.

A user can access the communication system by means of an appropriate communication device. A communication device of a user is often referred to as user equipment (UE) or terminal. A communication device is provided with an appropriate signal receiving and transmitting arrangement for enabling communications with other parties. Typically a communication device is used for enabling receiving and transmission of communications such as speech and data. In wireless systems a communication device provides a transceiver station that can communicate with another communication device such as e.g. a base station of an access network providing at least one cell and/or another user equipment. In certain applications, for example in adhoc networks, the communication system can be based on use of a plurality of user equipment capable of communicating with each other.

An example of communications systems is an architecture that is being standardized by the 3^{rd} Generation Partnership Project (3GPP) and is known as the long-term evolution (LTE) of the Universal Mobile Telecommunications System (UMTS) radio-access technology. The LTE technology aims to achieve various improvements, for example reduced latency, higher user data rates, improved system capacity and coverage, reduced cost for the operator and so on. A further development of the LTE is often referred to as LTE-Advanced. The various development stages of the 3GPP LTE specifications are referred to as releases.

Various reference signals may be provided. For example, 3GPP had specified use of uplink demodulation reference signals (UL DM RS). LTE release 8 defines sounding reference signals (SRS), and uplink (UL) link adaptation can be based on them. Sounding reference signals are used to provide information on uplink channel quality on a wider bandwidth than the current physical uplink shared channel (PUSCH) transmission or when the user equipment has no transmissions on the PUSCH. Channel estimation is provided by the base station, called eNB in the 3GPP, where after the obtained channel information can be utilized in the optimization of uplink scheduling. Sounding reference signals can be used also for other purposes, e.g. to facilitate uplink timing estimation for user equipments with narrow or infrequent uplink transmissions. Sounding reference signal can be transmitted on the last single-carrier frequency division multiple access (SC-FDMA) symbol of the sub-frame.

Different hopping methods can be used to randomize inter-cell interference for reference signals, for example demodulation and sounding reference signals. The pseudorandom hopping patterns can be cell specific and can be derived from the physical layer cell identity.

A new feature added into the LTE specifications in release 10 is that the communication system shall support for uplink (UL) multiple antenna transmission. A sounding reference signal (SRS) can be used to enable this to allow link adaptation and frequency domain packet scheduling in the uplink as well as precoder selection. Furthermore, due to channel reciprocity in time division duplexing (TDD) sounding reference signal (SRS) can be utilized for downlink (DL) link adaptation and precoding as well in multi-antenna systems.

Introduction of uplink multiple input multiple output (UL MIMO) techniques can have an impact on various aspects, for example on the sounding reference signal design. It has been agreed in the 3GPP that the uplink demodulation reference signals (UL DM RS) are precoded the same way as the data. Hence these references cannot typically be utilized for obtaining channel state information for link adaptation and precoder selection. Furthermore, the UL MIMO creates a need to sound multiple antennas, hence consuming more sounding reference signal resources. With single-user multiple input multiple output (SU-MIMO) as many cyclic shifts are required as is the rank of the transmission (up to four). Thus the availability of the sounding reference signal resources can become a bottleneck in a design such as those based on LTE release 10.

Transmission of a so called aperiodic sounding reference signal has been proposed to enable efficient usage of sounding reference signals with optimized overhead with e.g. UL MIMO. However, allocation of resources for aperiodic sounding reference signalling has not yet been addressed. Especially, there is no solution for enabling sounding reference signal hopping and/or multi-antenna transmission. Thus mechanisms enabling efficient usage of multi-antenna sounding reference signal and sounding reference signal hopping in a system such as LTE release 10 might be desired. Support for UL multi-antenna transmission and aperiodic sounding might also be desired. Although aperiodic sounding reference signalling, PDCCH based solutions and a new radio resource control (RRC) configuration have been proposed, there are no appropriate solutions for a hopping configuration which would also suit for multi-antenna sounding.

It is noted that the above discusses only examples, and the issues are not limited to any particular communication system, standard, specification and so forth, but may occur in any appropriate communication system where aperiodic reference signalling might be desired.

Embodiments of the invention aim to address one or several of the above issues.

In accordance with an embodiment there is provided a method of configuring at least one station, comprising defining a pattern of configuration indications for use in reference signalling, communicating information of the pattern of configuration indications to the at least one station for configuring the at least one station for reference signalling, and triggering transmission of a reference signal.

In accordance with another embodiment there is provided a method of configuring a station, comprising receiving information of a pattern of configuration indications, detecting a trigger for transmission of a reference signal, obtaining information of subframes that associate with reference signalling from the pattern of configuration indications, and configuring the station for transmission of the reference signal based on the information.

In accordance with another embodiment there is provided a control apparatus for configuring at least one station, the control apparatus comprising at least one processor, and at least one memory including computer program code, wherein the at least one memory and the computer program code are configured, with the at least one processor, to define a pattern of configuration indications for use in reference signalling, to cause communication of information of the pattern of configuration indications to the at least one station for configuring the at least one station for reference signalling, and to cause triggering of transmission of a reference signal.

In accordance with yet another embodiment there is provided a control apparatus for configuring a station, the control apparatus comprising at least one processor, and at least one memory including computer program code, wherein the at least one memory and the computer program code are configured, with the at least one processor, to obtain information of subframes that associate with reference signalling from a pattern of configuration indications, to detect a trigger for transmission of a reference signal, and to cause configuring of the station for transmission of the reference signal based on the information.

In accordance with a more detailed embodiment the reference signal comprises a sounding reference signal. The pattern can be a time-dependent pattern. Resources for aperiodic sounding reference signalling can be allocated by means of the pattern. The pattern can indicate a hopping pattern and/or antenna configuration for reference signalling.

The pattern can be used for switching between single antenna port sounding and multi-antenna sounding.

Information of the pattern can be communicated on a signalling layer that is higher than the layer used for communication of the reference signal.

The pattern can indicate, for the transmission of the reference signal, at least one of frequency allocations, a cyclic shift and a transmission comb.

A trigger for the transmission of the reference signal can be communicated in an uplink grant or a downlink assignment.

The information can be obtained from the pattern before, at the same time or after the detection of the trigger.

The reference signal can be transmitted in the next available subframe indicated by the pattern after detection of the trigger. The reference signal can be transmitted in a predefined number of subframes.

Transmission parameters can be obtained for each transmission instance based on a relevant pattern of subframes.

Multi-antenna sounding can be triggered by the pattern. A sounding reference signal can be sent from a single antenna at a time in accordance with a pattern.

The station can comprise a user equipment, and the pattern can consist of user equipment specific subframes and/or cell specific subframes.

The pattern can comprise information of at least one of station specific sounding reference signal bandwidth, station specific sounding reference signal starting position, station specific sounding reference signal hopping bandwidth, station specific sounding reference signal subframe periodicity, station specific sounding reference signal subframe offset and subframes for multi-antenna transmission.

A communication device and/or base station comprising a control apparatus configured to provide at least one of the embodiments can also be provided. The communication device may comprise a user equipment.

A computer program comprising program code means adapted to perform the herein described methods may also be provided. In accordance with further embodiments apparatus and/or computer program product that can be embodied on a computer readable medium for providing at least one of the above methods is provided.

Various other aspects and further embodiments are also described in the following detailed description of examples embodying the invention and in the attached claims.

The invention will now be described in further detail, by way of example only, with reference to the following examples and accompanying drawings, in which:

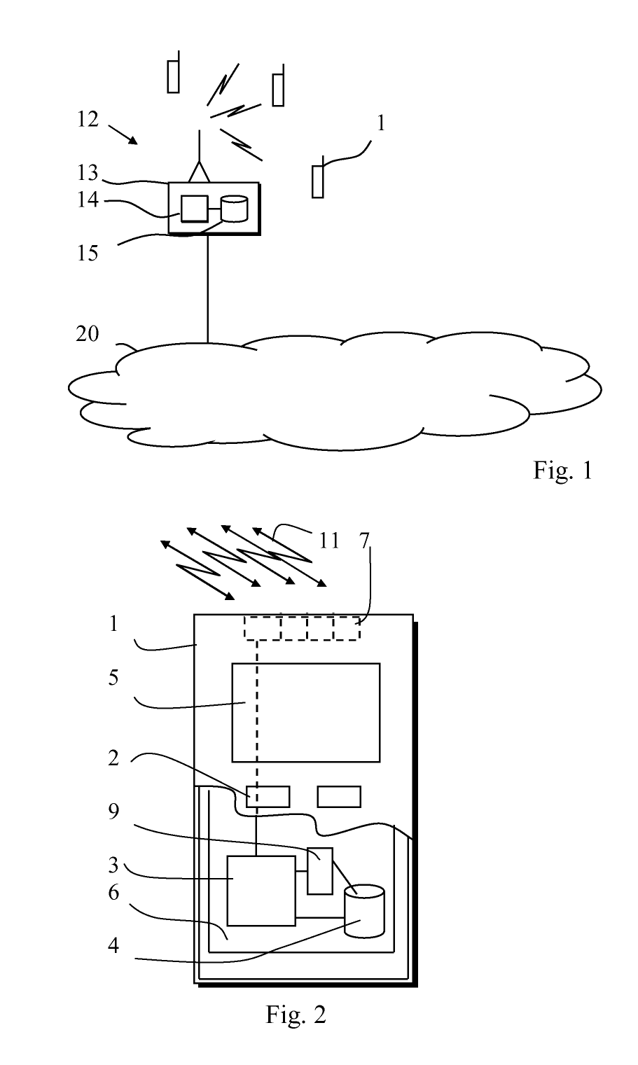

FIG. 1 shows an example of a communication system wherein below described examples of the invention may be implemented;

FIG. 2 shows an example of a communication device;

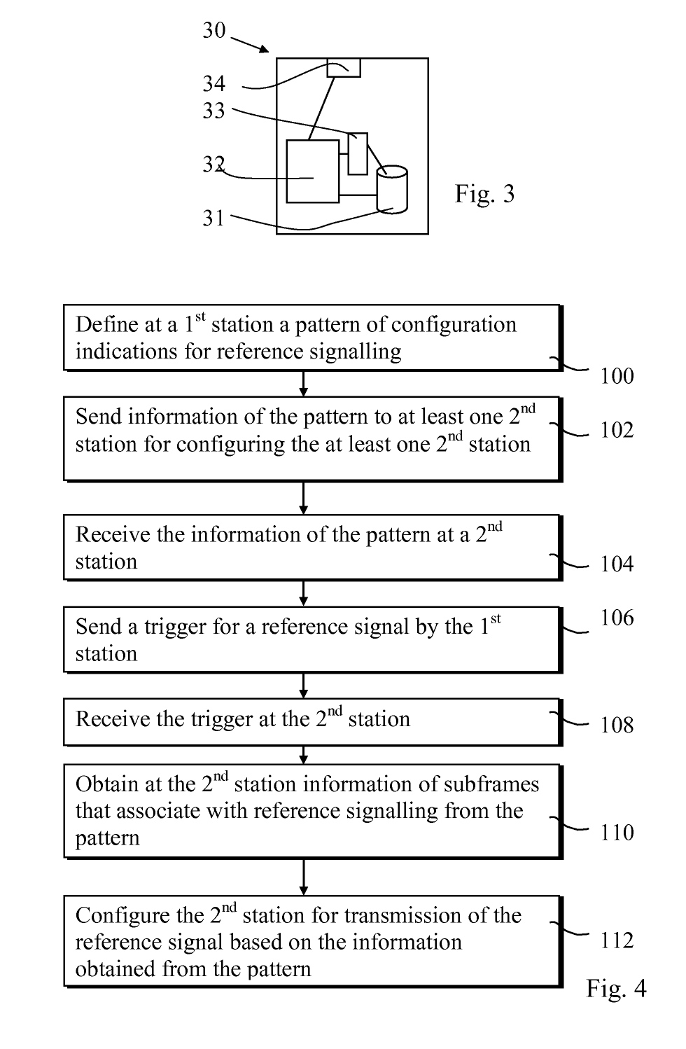

FIG. 3 shows an example of controller apparatus for a base station;

FIG. 4 is flowchart illustrating an embodiment; and

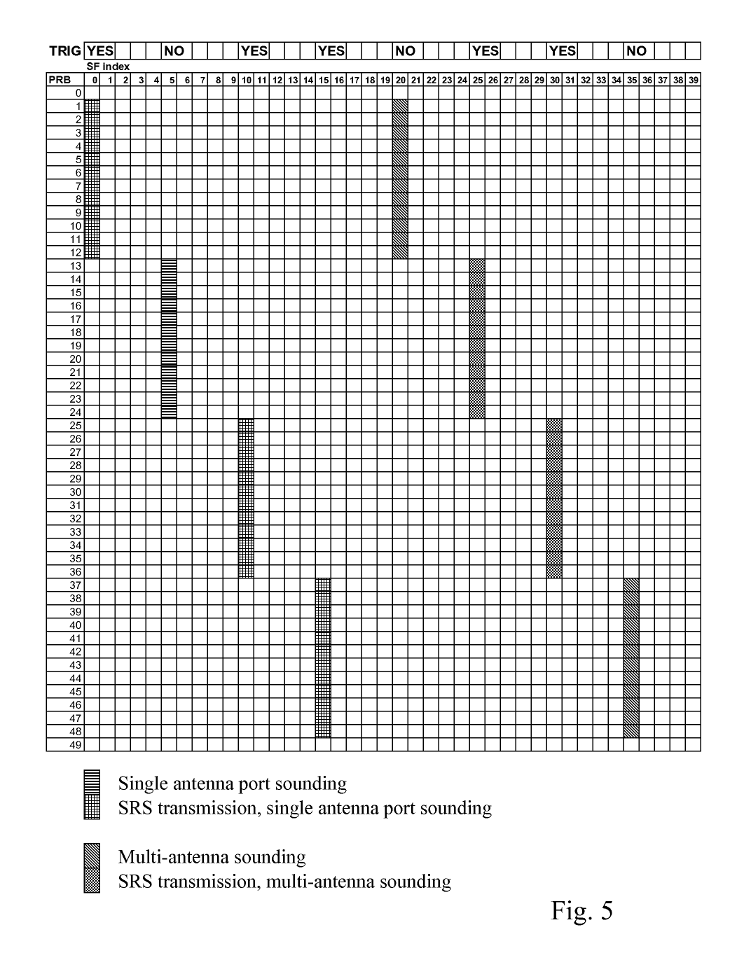

FIG. 5 is an example for a resource allocation pattern.

In the following certain exemplifying embodiments are explained with reference to a wireless or mobile communication system serving mobile communication devices. Before explaining in detail the exemplifying embodiments, certain general principles of a wireless communication system, control apparatus thereof and mobile communication devices are briefly explained with reference to FIGS. 1 to 3 to assist in understanding the technology underlying the described examples.

A communication device may provide, for example, communication of data for carrying communications such as voice, electronic mail (email), text message, multimedia and so on. A mobile communication device 1 can be used for accessing various services and/or applications provided via a communication system. Mobile users may thus be offered and provided numerous services via their mobile communication devices. Non-limiting examples of these services include two-way or multi-way calls, data communication or multimedia services or simply an access to a data communications network system, such as the Internet. User may also be provided broadcast or multicast data. Non-limiting examples of the content include downloads, television and radio programs, videos, advertisements, various alerts and other information.

A mobile communication device 1 is typically provided wireless access via at least one base station 12 or similar wireless transmitter and/or receiver node of an access system. It is noted that although only one access systems is shown, any number of access systems may be provided in a communication system. An access system may be provided by a cell of a cellular system or another system enabling a communication device to access a communication system. A base station site 12 can provide one or more cells of the plurality of cells of a cellular communication system. A base station can be configured to provide a cell, but a base station can also provide, for example, three sectors, each sector providing a cell. Each mobile communication device 1 and base station 12 may have one or more radio channels open at the same time and may send signals to and/or receive signals from more than one source.

A base station 12 is typically controlled by at least one appropriate controller so as to enable operation thereof and management of mobile communication devices 1 in communication with the base station. The control apparatus can be interconnected with other control entities. In FIG. 1 a controller apparatus is shown to be provided by block 13. A base station control apparatus is typically provided with memory capacity 15 and at least one data processor 14. It shall be understood that the control apparatus and functions thereof may be distributed between a plurality of control units.

The communication devices 1 can access the communication system based on various access techniques, such as code division multiple access (CDMA), or wideband CDMA (WCDMA). Other examples include time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

A non-limiting example of the recent developments in communication systems is the long-term evolution (LTE) of the Universal Mobile Telecommunications System (UMTS) that is being standardized by the 3^{rd} Generation Partnership Project (3GPP). As explained above, further development of the LTE is referred to as LTE-Advanced. Non-limiting examples of appropriate access nodes are a base station of a cellular system, for example what is known as NodeB (NB) in the vocabulary of the 3GPP specifications. The LTE employs a mobile architecture known as the Evolved Universal Terrestrial Radio Access Network (E-UTRAN). Base stations of such systems are known as evolved Node Bs (eNBs) and may provide E-UTRAN features such as user plane Radio Link Control/Medium Access Control/Physical layer protocol (RLC/MAC/PHY) and control plane Radio Resource Control (RRC) protocol terminations towards the user devices. Other examples of radio access system include those provided by base stations of systems that are based on technologies such as wireless local area network (WLAN) and/or WiMax (Worldwide Interoperability for Microwave Access).

In FIG. 1 example the base stations of the access systems are connected to a wider communications network 20. A controller may be provided in the network 20 for coordinating the operation of the access systems. Although not shown, a gateway function may also be provided to connect to another network via the network 20. The other network may be any appropriate network, for example another communication network, a packet data network and so on. A wider communication system may thus be provided by one or more interconnect networks and the elements thereof, and one or more gateways may be provided for interconnecting various networks.

FIG. 2 shows a schematic, partially sectioned view of a communication device 1 that a user can use for communication. Such a communication device is often referred to as user equipment (UE). An appropriate mobile communication device may be provided by any device capable of sending and receiving radio signals. Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A mobile communication device may be used for voice and video calls, for accessing service applications and so on. The mobile device 1 may receive signals over an air interface 11 via appropriate apparatus for receiving and may transmit signals via appropriate apparatus for transmitting radio signals. In FIG. 2 transceiver apparatus is designated schematically by blocks 7. The transceiver may be provided for example by means of a radio part and associated antenna arrangement. The antenna arrangement may be arranged internally or externally to the mobile device.

A wireless communication device can be provided with a Multiple Input/Multiple Output (MIMO) antenna system, this being denoted by the four antenna blocks 7 and the plurality of signals 11. MIMO arrangements as such are known. MIMO systems use multiple antennas at the transmitter and receiver along with advanced digital signal processing to improve link quality and capacity. The multiple antennas can be provided, for example at base stations and mobile stations. More data can be received and/or sent where there are more antennae elements. A station may comprise an array of multiple antennae.

A user equipment may also be provided with single antenna only, or then configured to use a single antenna port. It is noted that the difference between definitions “single antenna” and “single antenna port” is that a device with a single antenna can send signals only from a single antenna whereas “single antenna port” means that the transmitted signal resembles single antenna transmission but may be transmitted from multiple antennas in a transparent manner.

A mobile device is also typically provided with at least one data processing entity 3, at least one memory 4 and other possible components 9 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 6. Possible control functions in view of configuring the device for transmission of reference signals by means of the data processing facility in accordance with certain embodiments of the present invention will be described later in this description.

The user may control the operation of the mobile device by means of a suitable user interface such as key pad 2, voice commands, touch sensitive screen or pad, combinations thereof or the like. A display 5, a speaker and a microphone are also typically provided. Furthermore, a mobile communication device may comprise appropriate connectors (either wired or wireless) to other devices and/or for connecting external accessories, for example hands-free equipment, thereto.

FIG. 3 shows an example of a control apparatus 30 for a communication system, for example to be coupled to and/or for controlling a station of an access system. The control apparatus 30 can be arranged to provide control on communications by mobile communication devices that are in the area of the system. The control apparatus 30 can be configured to facilitate use of configuration patterns as will be described in more detail below. For this purpose the control apparatus comprises at least one memory 31, at least one data processing unit 32, 33 and an input/output interface 34. Via the interface the control apparatus can be coupled to a receiver and a transmitter of the base station. The control apparatus 30 can be configured to execute an appropriate software code to provide the control functions as explained below.

The required data processing apparatus and functions of a base station apparatus, a communication device and any other appropriate station may be provided by means of one or more data processors. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor-based memory devices, magnetic memory devices and systems, optical memory devices and systems, fixed memory and removable memory.

Certain exemplifying embodiments of the invention are now described with reference to 3GPP LTE. Some particular embodiment are described with reference to LTE releases 8 and 10 in the context of LTE release 10 compatible Multiple Input/Multiple Output (MIMO) system and uplink (UL) multiple antenna transmissions. The exemplifying embodiments provide a resource allocation mechanism for aperiodic sounding reference signals (SRS). The mechanism can take into account uplink (UL) multi-antenna transmission.

Sounding reference signal transmissions can be flexibly configured. Sounding reference signal transmission can be a single transmission or periodic, the period typically ranging from 2 ms to 320 ms. At the present there can be up to four different sounding reference signal bandwidth options available, depending on the system bandwidth and cell configuration. Sounding reference signal transmission can also hop in frequency. This is particularly beneficial for communication devices on a cell edge which cannot support wideband sounding reference signal transmissions. Frequency hopping can also be limited to a certain portion of system bandwidth. This can be beneficial for inter-cell interference coordination. Sounding reference signal configuration can be explicitly signaled via terminal specific higher layer signaling. The signaling can be common or dedicated. Sounding reference signal transmissions from different communication devices can be multiplexed in multiple dimensions:
In time: periodic SRS transmissions can be interleaved into different subframes with subframe offsets.
In frequency: To facilitate frequency division multiplexing, the available SRS bandwidths follow a tree structure, where a set of available SRS bandwidths is reserved for a certain cell configuration. SRS frequency hopping pattern can follow also the tree structure.
With cyclic shifts: up to eight cyclic shifts can be configured. However, the cyclic shift multiplexed signals shall have the same bandwidth to maintain orthogonality. Due to the intensive use of cyclic shifts, the sequence group configured for physical uplink control channel (PUCCH) is used also for SRS.
Transmission comb in the distributed transmission: two combs are typically available. Contrary to cyclic shifts, transmission comb does not require that the multiplexed signals occupy the same bandwidth.

In addition to the device specific SRS configuration, cell specific SRS configuration can be used. Cell specific SRS configuration defines the subframes which can contain SRS transmissions as well as the set of SRS bandwidths available in the cell. SRS transmissions are not allowed to extend into the frequency band reserved for the PUCCH. Therefore, multiple SRS bandwidth sets are typically needed for a flexible cell specific PUCCH configuration.

In accordance with an embodiment illustrated by the flowchart of FIG. 4 a first station, for example a base station 12 of FIG. 1, can configure at least one second station, for example a mobile user equipment of FIGS. 1 and 2. The control apparatus of the first station can define at 100 a pattern of configuration indications for use in transmission of a reference signal by the at least one second station within the area thereof. The pattern can be a time-dependent pattern. The first station can then send the information at 102 to the second stations receiving it. More particularly, information of the pattern can be communicated to the at least one second station so as to enable configuring of the at least one second station for reference signalling. This can be done, for example, with higher layer signalling, for example based on RRC. After this the first station can then send a trigger at 106 to one or more of the second stations to trigger sending of a reference signal by at least one second station.

A second station can receive the information of the pattern at 104. After reception of the information the second station can also receive and detect the trigger at 108. The second station can analyse the information at 110 to obtain information of subframes that associate with reference signalling from the pattern. The second station can be configured and the reference signal transmitted at 112 accordingly. The configuration can take into account indicated frequency and antenna resources, and can take place in at least one of the subframes as indicated by the pattern.

It is noted that the triggering can take place before or after the information for the reference signal configuration is obtained by the second station. Thus steps 108 and 110 can be provided in different order from that shown, or in parallel.

In accordance with a particular embodiment the reference signal comprises a sounding reference signal (SRS). There can be provided a mechanism for indicating resource allocation for aperiodic SRS supporting both SRS hopping and switching between single and multi-antenna sounding. In the mechanism a aperiodic SRS configuration pattern can be defined. The pattern can consists of a set of user equipment (UE) or cell specific subframes in which aperiodic SRS transmission may take place, if triggered.

The pattern may indicate to the user equipment at each time instance one or more appropriate parameter. A parameter may indicate allocated frequency resources, typically the physical resource blocks (PRBs). Alternatively, or in addition, an indication of the appropriate antenna configuration to apply can be given. For example, an indication if a single antenna port mode or a multi-antenna transmission shall apply can be given. The SRS cyclic shift can also be indicated. This is typically, but not necessarily constant for a given antenna configuration. The SRS transmission comb can also be indicated. Again, this is typically but not necessarily constant for a given antenna configuration.

A user equipment can receive an aperiodic SRS trigger in a physical downlink control channel (PDCCH) uplink (UL) grant or a downlink (DL) assignment. When the user equipment receives the aperiodic SRS trigger it can start to transmit the SRS according to the pattern in the next possible aperiodic SRS subframe. The transmission can take place over a predefined number of subframes. For example, the transmission can take place for as many subframes as it has been configured to do so in the case of timer based SRS trigger. It can also be assumed the user equipment can send the aperiodic SRS at earliest four subframes after the reception of the PDCCH containing the trigger (i.e. in the UL subframe # n+4, where n is the DL subframe carrying the trigger). This corresponds to the case with hybrid automatic repeat request (HARQ) timing in general. It is also possible to have other timer based solutions. The aperiodic SRS transmission can also be a single-shot transmission, i.e. the predefined number of transmission is 1.

A particular example illustrating an embodiment is presented in FIG. 5. In the shown example a user equipment can select at least one transmission parameter according to the present state of a received pattern in each transmission instance. The user equipment can get the parameters by sub-sampling the pattern, and thus in the example resource allocation for aperiodic SRS transmission can be obtained by sub-sampling an aperiodic SRS configuration pattern. In the example blocks 50 with horizontal lines indicate resources allocated for single antenna port (sounding) transmissions and blocks 54 with diagonal lines indicate resources for multi-antenna transmissions. Blocks 52 and 56 are allocated resources where the transmission has been enabled by a trigger.

The time-dependent resource allocation pattern can be used to indicate the hopping pattern, or the physical resource block (PRB) indices to use, the user equipment specific SRS subframes (subframes 0, 5, 10, 15, 20, 25, 30 and 35 in the example), and the antenna configuration.

The SRS trigger is shown on line 58. As shown, transmission of sounding reference signal (SRS) takes place only in subframes #0, 10, 15, 25, and 30, when enabled by the PDCCH trigger (denoted ‘YES’). For example, a trigger transmitted on the PDCCH in a downlink subframe #n can be used to initiate an aperiodic SRS transmission in a uplink subframe #n+4 at earliest or in the first available/configured UL subframe. When a user equipment receives the aperiodic SRS trigger corresponding to a given subframe it can determine the physical resources and the antenna configuration to apply based on the pattern. For example, the user equipment can send the first aperiodic SRS in subframe #0 with PRBs 1-12, using single antenna port mode. In the next user equipment specific aperiodic SRS subframe (#5) the user equipment has not received the SRS trigger in time and will not transmit SRS. Typically this would mean that the user equipment has not received the trigger at least four subframes earlier. Then again, in subframe #10 the user equipment can send the aperiodic SRS according to the parameter indicated by the pattern.

Multiple bits and/or states can be available for aperiodic SRS triggering in the uplink grant or the downlink assignment. In accordance with an embodiment these can be used to indicate whether a single or multi-antenna SRS transmission (i.e. sounding) should take place.

Furthermore, in multi-antenna sounding, when triggered, it is also possible to send SRS from one antenna at the time according to a predefined pattern. This option has the advantage that only a single cyclic shift/comb resource is required. This can be used to further simplify the resource allocation.

To further assist in understanding the description of the example given in the context of LTE release 10, a brief reference is now made to LTE release 8 SRS resource configuration. The LTE release 8 SRS resource configuration parameters are shown in Table 1 below.

TABLE 1

| | |
|---|---|
| Frequency Domain: | |
| C_SRS = | Srs-BandwidthConfig (cell specific), {0 . . . |
| | 7} |
| B_SRS = | Srs-Bandwidth (UE specific), {0 . . . 3} |
| n_rrc = | UE specific (starting) frequency domain |
| | position |
| b_hop = | UE specific srs-HoppingBandwidth {0, . . . 3} |
| Time Domain: | |
| T_srs = | UE-specific periodicity {2, 5, 10, 20, 40, |
| | 80, 160, 320} |
| T_offset = | UE-specific subframe offset depending on |
| | T_srs |
| Duration | Duration of the SRS allocation: single of |
| | indefinite |
| T_sfc = | cell specific subframe configuration {1, |
| | 2, 5, 10} |
| Other: | |
| k_TC | Transmission Comb (UE specific) |
| Cyclic shift | N_srs_cs (UE specific) |

In an embodiment the cell specific parameters can be sufficient as such. Additionally, some new user equipment specific parameters may need to be defined in certain situations. For example, it can be advantageous to be able to configure user equipment specific SRS bandwidth, starting position, and hopping bandwidth separately for the aperiodic SRS transmission. Furthermore, it can also be beneficial to be able to define a new user equipment specific periodicity parameter, herein called T_srs_aper, to indicate which of the cell specific subframes are enabled for aperiodic SRS transmission for a given user equipment. It is noted that in a special case of this it is possible to trigger aperiodic SRS in all cell specific SRS subframes by setting T_srs_aper=1.

Another new parameter (or parameters) can be used to indicate which subframes in the pattern correspond to multi-antenna transmission. This parameter or parameters may indicate e.g. the ratio of multi-antenna SRS resources in the pattern, and/or the periodicity at which multi-antenna resources occur and/or the relative timing offset with respect to single antenna port SRS subframes. It is also possible to define separate configuration parameters for single- and multi-antenna cases.

An exemplary set for the above discussed radio resource control (RRC) parameters for configuring aperiodic SRS transmission are shown in Table 2.

TABLE 2

| | |
|---|---|
| Frequency Domain: | |
| B_SRS_aper = | Srs-Bandwidth for aperiodic SRS (UE speci- |
| | fic), {0 . . . 3} |
| n_rrc_aper = | UE specific (starting) frequency domain posi- |
| | tion for aperiodic SRS |
| b_hop_aper = | UE specific srs-HoppingBandwidth for aperio- |
| | dic SRS {0, . . . 3} |
| Time Domain: | |
| T_srs_aper = | UE-specific periodicity for aperiodic SRS {1, |
| | 2, 5, 10, 20, 40, 80, 160, 320} |
| T_offset_aper = | UE-specific subframe offset for aperiodic SRS |
| | depending on T_srs |
| Duration_aper = | interpretation of the SRS trigger: single |
| | shot or N {1, . . . N} |
| R_srs_multiant | Ratio of multi-antenna SRS resources in the |
| | pattern {none, all, every 2^{nd}, 3^{rd}, etc. cyc- |
| | le . . .} |

An appropriately adapted computer program code product or products may be used for implementing the embodiments, when loaded or otherwise provided on an appropriate data processing apparatus, for example for causing definition of appropriate patterns, communications of the related information between the various nodes and configuring a transmitting station. The program code product for providing the operation may be stored on, provided and embodied by means of an appropriate carrier medium. An appropriate computer program can be embodied on a computer readable record medium. A possibility is to download the program code product via a data network. In general, the various embodiments may be implemented in hardware or special purpose circuits, software, logic or any combination thereof. Embodiments of the inventions may thus be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The embodiments can provide advantage for example because sounding reference signal hopping can be provided aperiodically. Sub-sampling of the SRS hopping pattern provides a simple and robust solution to perform aperiodic sounding. Switching between single and multi-antenna port sounding can be enabled. This can be provided without introducing any, or with a little, signaling overhead. SRS overhead can be minimized by enabling efficient utilization of aperiodic SRS.

It is noted that whilst embodiments have been described in relation to communications system such as those based on the LTE and 3GPP based systems, similar principles can be applied to any other communication system where reference signals are used. Instead of uplink reference signalling, this may occur in the downlink, or between substantially similar stations. Thus, instead of communications between base station and communication devices such as a user equipment the communications may be provided directly between two or more user equipment. For example, this may be the case in application where no fixed station equipment is provided but a communication system is provided by means of a plurality of user equipment, for example in adhoc networks. Also, the above principles can also be used in networks where relay nodes are employed for relaying transmissions between stations. Therefore, although certain embodiments were described above by way of example with reference to certain exemplifying architectures for wireless networks, technologies and standards, embodiments may be applied to any other suitable forms of communication systems than those illustrated and described herein.

It is also noted herein that while the above describes exemplifying embodiments of the invention, there are several variations and modifications which may be made to the disclosed solution without departing from the spirit and scope of the present invention.

1. A method of configuring at least one station, comprising defining a pattern of configuration indications for use in reference signalling;
communicating information of the pattern of configuration indications to the at least one station for configuring the at least one station for reference signalling; and
triggering transmission of a reference signal.

2. A method of configuring a station, comprising
receiving information of a pattern of configuration indications;
detecting a trigger for transmission of a reference signal;
obtaining information of subframes that associate with reference signalling from the pattern of configuration indications; and
configuring the station for transmission of the reference signal based on the information.

3. A method as claimed in claim 1, wherein the reference signal comprises a sounding reference signal.

4. A method as claimed in claim 1, wherein the pattern comprises a time-dependent pattern.

5. A method as claimed in claim 1, comprising allocating resources for aperiodic sounding reference signalling, wherein the pattern is indicative of a hopping pattern and/or antenna configuration.

6. A method as claimed in claim 1, comprising using the pattern for switching between single antenna port sounding and multi-antenna sounding.

7. A method as claimed in claim 1, comprising communicating information of the pattern on a signalling layer that is higher than the layer used for communication of the reference signal.

8. A method as claimed in claim 1, wherein the pattern indicates, for the transmission of the reference signal, at least one of frequency allocations, a cyclic shift and a transmission comb.

9. A method as claimed in claim 1, comprising communicating a trigger for the transmission of the reference signal in an uplink grant or a downlink assignment.

10. A method as claimed in claim 2, wherein the information is obtained before or after the detection of the trigger.

11. A method as claimed in claim 2, transmitting, in response to the trigger, the reference signal in the next available subframe indicated by the pattern.

12. A method as claimed in claim 11, comprising transmitting the reference signal in a predefined number of subframes.

13. A method as claimed in claim 1, comprising obtaining transmission parameters for each transmission instance based on a relevant pattern of subframes.

14. A method as claimed in claim 1, comprising triggering multi-antenna sounding, and sending a sounding reference signal from a single antenna at a time in accordance with a pattern.

15. A method as claimed in claim 1, wherein the station comprises a user equipment, and the pattern consist of user equipment specific subframes and/or cell specific subframes

16. A method as claimed in claim 1, wherein the pattern comprises information of at least one of station specific sounding reference signal bandwidth, station specific sounding reference signal starting position, station specific sounding reference signal hopping bandwidth, station specific sounding reference signal subframe periodicity, station specific sounding reference signal subframe offset and subframes for multi-antenna transmission.

17. A control apparatus for configuring at least one station, the control apparatus comprising at least one processor, and at least one memory including computer program code, wherein the at least one memory and the computer program code are configured, with the at least one processor,
to define a pattern of configuration indications for use in reference signalling,
to cause communication of information of the pattern of configuration indications to the at least one station for configuring the at least one station for reference signalling, and to cause triggering of transmission of a reference signal.

18. A control apparatus for configuring a station, the control apparatus comprising at least one processor, and at least one memory including computer program code, wherein the at least one memory and the computer program code are configured, with the at least one processor,
to obtain information of subframes that associate with reference signalling from a pattern of configuration indications,
to detect a trigger for transmission of a reference signal, and
to cause configuring of the station for transmission of the reference signal based on the information.

19. A control apparatus as claimed in claim 17, wherein the reference signal comprises a sounding reference signal.

20. A control apparatus as claimed in claim 17, wherein the pattern comprises a time-dependent pattern.

21. A control apparatus as claimed in claim 17, configured to allocate resources for aperiodic sounding reference signalling, wherein the pattern is indicative of a hopping pattern and/or antenna configuration.

22. A control apparatus as claimed in claim 17, configured to control sounding reference signalling in a multiple input multiple output communication system based on the pattern.

23. A control apparatus as claimed in claim 17, configured to cause communication of information of the pattern on a signalling layer that is higher than the layer used for communication of the reference signal.

24. A control apparatus as claimed in claim 17, wherein the pattern indicates, for use in transmission of the reference signal, at least one of allocation of frequency resources, cyclic shift and a transmission comb.

25. A control apparatus as claimed in claim 17, configured to send and/or detect a trigger for transmission of the reference signal.

26. A control apparatus as claimed in claim 18, configured to cause transmission of the reference signal in the next available aperiodic subframe in response to detection of the trigger.

27. A control apparatus as claimed in claim 18, configured to cause transmission of the reference signal in a predefined number of subframes.

28. A control apparatus as claimed in claim 18, configured to obtain transmission parameters for each transmission instance based on a relevant pattern of subframes.

29. A control apparatus as claimed in claim 18, configured to cause sending of a sounding reference signal from a single antenna at a time in accordance with a pattern in response to detection of multi-antenna sounding.

30.-34. (canceled)
